(19) United States
(12) Patent Application Publication
(10) Pub. No.: US 2013/0057460 A1
(43) Pub. Date: Mar. 7, 2013

(54) LCD driving circuit, data-driven chip, liquid crystal panel and liquid crystal display device

(71) Applicant: Dongsheng Guo, Shenzhen (CN)

(72) Inventor: Dongsheng Guo, Shenzhen (CN)

(21) Appl. No.: 13/378,818

(22) PCT Filed: Dec. 3, 2011
(86) PCT No.: PCT/CN11/83422

§ 371 Date: Dec. 16, 2011

(30) Foreign Application Priority Data
Sep. 6, 2011 (CN) 201110262651.4

(51) Int. Cl. G09G 3/36

(52) U.S. Cl. 345/87

(57) ABSTRACT

The invention discloses an LCD driving circuit, a data-driven chip, a liquid crystal panel, and a liquid crystal display. The LCD driving circuit comprises a data-driven chip with a plurality of output ends, and a plurality of data lines connected to the output ends of the data-driven chip respectively. Output resistors are arranged between the output ends of the data-driven chip and the data lines respectively; equivalent resistances of the data lines are different; and the equivalent resistance of each of the data lines is equal to the sum of the output resistances corresponding to the data line. The invention adopts the output resistors to substitute serpentine windings. Because the width occupied by the output resistances is less than the width occupied by the serpentine windings, a winding space in a glass substrate can be saved to realize a narrow frame design. In addition, because a frame per unit width can accommodate more data lines, thus the cost can be decreased.

The invention relates to the field of liquid crystal displays, and more particularly to a LCD driving circuit, a data-driven chip, a liquid crystal panel, and a liquid crystal display.

### BACKGROUND

At present, the data lines in the LCD glass adopt serpentine windings when output from the data-driven chip. Thus, the line impedance of pixel 4 is basically consistent. As shown in FIG. 1, a connecting finger 21 of COF 1 (the data-driven chip laminated on a film) is laminated on a lead of the glass substrate 2 and connected to a pixel 4 of the glass substrate through a section of winding 3 so as to make all output resistances matched. FIG. 2 is an enlarged view of the winding 3. As shown in FIG. 3, the serpentine windings 3 of the glass substrate of each channel are considered as equivalent resistances. These equivalent resistances are matched and equal: R1=R2= . . . =Rn−1=Rn=Rn+1= . . . =R2n, and impedance of each row of data is the same. When all output channels are on to supply voltage to the pixel 4, the charge times of pixel dots in the same row are the same. Therefore, the picture homogenization is good. On the contrary, if the impedances are different, the charge times of the pixel dots 4 in the same row are different, and the indications at the COF control area 1 are uneven. As the amount of single COF output channels increases, the space accommodating the serpentine windings for impedance matching becomes bigger (to meet output compensation), but the development of the frame tends to be narrow at present, and the space for the winding 3 is gradually reduced. If the resistance matching problem can be solved by other methods, the winding 3 will not be adopted, and the frame of the glass substrate can be narrower to further decrease the cost.

### SUMMARY

The aim of the invention is to provide an LCD driving circuit, a data-driven chip, a liquid crystal panel, and a liquid crystal display (LCD) that feature reduced glass wiring space and a narrow frame.

The purpose of the invention is achieved by the following technical schemes:

An LCD driving circuit comprises a data-driven chip with a plurality of output ends, and a plurality of data lines connected to the output ends of the data-driven chip respectively, wherein output resistors are arranged between the output ends of the data-driven chip and the data lines respectively; equivalent resistances of the data lines are different; and the equivalent resistance of each of the data lines is equal to the sum of the output resistances corresponding to the data line.

Preferably, the output ends of the data-driven chip are respectively connected to the data lines on a glass substrate by the output resistors in series connection. The technical scheme can reduce the occupied space for the data lines on the glass substrate.

Preferably, the output resistors are integrated in the data-driven chip. The technical scheme has a higher integration.

The output resistors can also be arranged on a glass substrate where the data lines are arranged.

Preferably, the output resistors are adjustable resistors. The adjustable resistors can improve the generality of the output resistors, and the resistances thereof are adjustable according to specific applications.

Preferably, the data-driven chip is arranged on a flexible circuit board, which is a COF packaging method of the data-driven chip.

Preferably, the data-driven chip is directly connected to a lead arranged on an LCD laminated area, which is a COG packaging method of the data-driven chip.

A data-driven chip, wherein output ends of the data-driven chip are respectively connected to output resistors matched with equivalent resistances of data lines connected to a data-driven chip correspondingly.

A liquid crystal panel comprises the LCD driving circuit.

A liquid crystal display comprises the liquid crystal panel.

The invention adopts the output resistors with higher resistivity compared to the data line to substitute serpentine windings. Because the space occupied by the output resistors is far less than the space occupied by the serpentine windings, the winding space of the glass substrate can be reduced to realize a narrow frame design. In addition, because the frame per unit width can accommodate more data lines, the cost is reduced.

### DESCRIPTION OF FIGURES

FIG. 1 is a schematic diagram of a COF output channel;

FIG. 2 is a schematic diagram of a serpentine winding of a COF output channel in the prior art;

FIG. 3 is a schematic diagram of an equivalent resistance of a serpentine winding of a COF output channel in the prior art;

FIG. 4 is a schematic diagram of a serpentine winding without a lead area of a glass substrate in the invention;

FIG. 5 is a schematic diagram of an equivalent resistance of the data line without a serpentine winding; and

FIG. 6 is a schematic diagram of the invention.

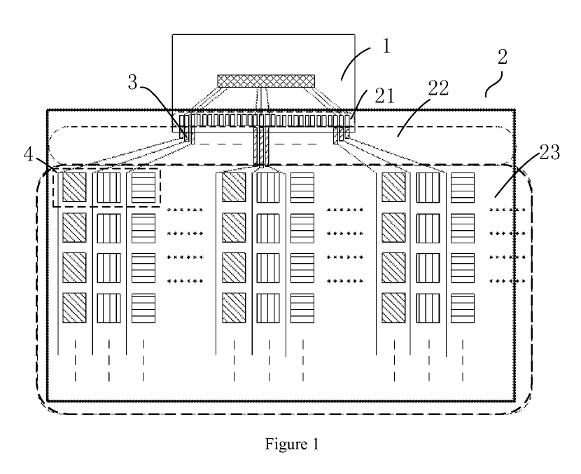

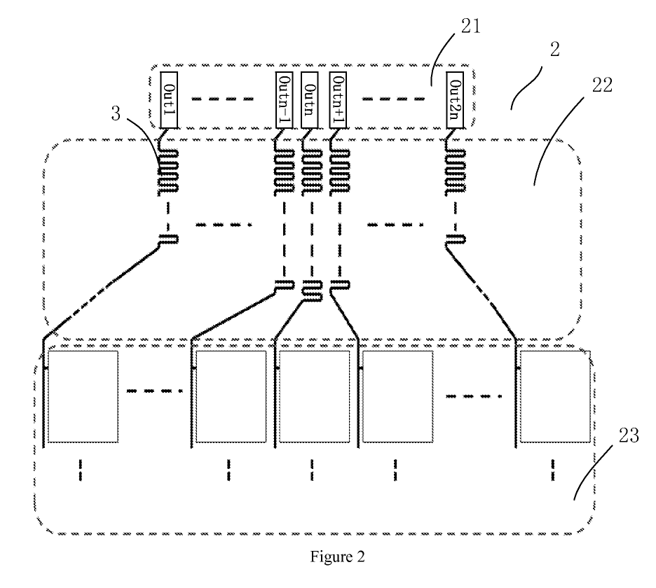

Wherein: 1. COF, 2. glass substrate, 21. connecting finger, 22. lead area, 23. pixel area, 3. serpentine winding, 4. pixel.

### DETAILED DESCRIPTION

The invention is further described by figures and the preferred embodiments as follows.

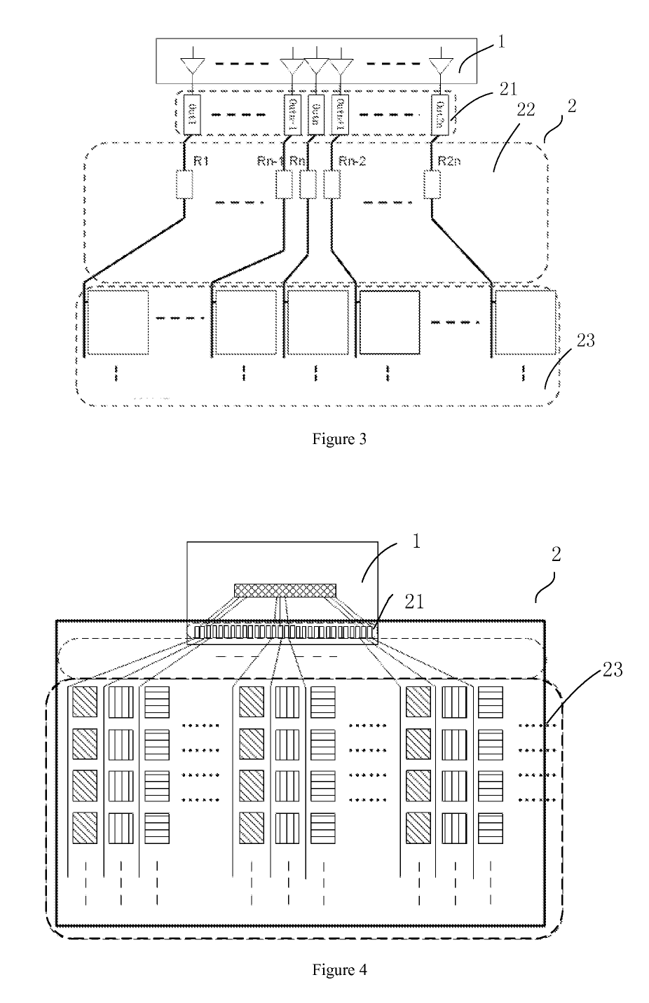

As shown in FIGS. 4 and 5, a liquid crystal panel of a liquid crystal display comprises an LCD driving circuit. The LCD driving circuit comprises a data-driven chip with a plurality of output ends, and a plurality of data lines connected to the output ends of the data-driven chip respectively. Output resistors are arranged between the output ends of the data-driven chip and each data line respectively. The equivalent resistances of the data lines are different. The equivalent resistance of each of the data lines is equal to the sum of the output resistances corresponding to the data lines. The data-driven chip can adopt a COG method (i.e. the data-driven chip is directly laminated on a film, and connected to a lead arranged on an LCD laminated area) or COF method (i.e. the data-driven chip is arranged on a flexible circuit board, and laminated on the film by a flexible circuit board). Take the COF1 as an example. The COF1 is laminated on the data line of a glass substrate 22 by a connecting finger 21. The data line enters the pixel area 23 through the lead area 22 to drive the pixels 4 in each column. The output resistors can be arranged in the data-driven chip, or arranged on a glass substrate 2 where the data lines are arranged. The conception of the invention is further interpreted by the embodiment of the output resistances in the data-driven chip as follows:

As shown in FIG. 4, the serpentine winding can be not arranged at the lead area of the glass substrate 2, so that the frame of the glass substrate 2 can be narrower. However, this can cause the output resistances from all COF output channels on the glass substrate 2 to be different. As shown in FIG. 5, if COF 1 has 2n output channels, the equivalent resistances R1 . . . R2n of the channels are different; for each row of pixels 4, when all output channels are on simultaneously, the resistances between the output channels and each row are different; if the output delay times are different, the charge times are also different.

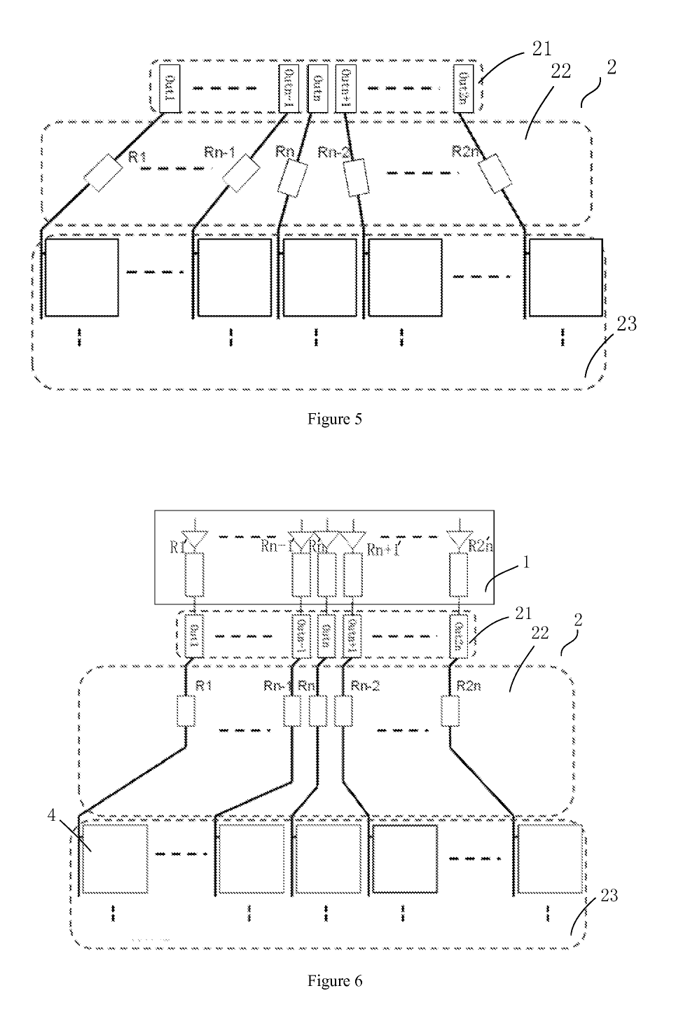

As shown in FIG. 6, the output resistances (R1′ to R2n′) of the output channels of the data-driven chip can be increased to obtain R1+R1′=R2+R2′= . . . =R2n+R2n′, so the equivalent resistances of each row of pixels 4 are the same; if the applicable delay times of each row of pixels are the same, the charge times are the same; and the purpose for matching the resistance of each data line in the glass substrate 2 is achieved. The output resistor can be easily added to each channel in the data-driven chip. Therefore, the winding space on the glass substrate 2 is saved and thus a narrow frame achieved, and the COF with more channels can also be used.

The invention is described in detail in accordance with the above contents with the specific preferred embodiments. However, this invention is not limited to the specific embodiments. For the ordinary technical personnel of the technical field of the invention, on the premise of keeping the concept of the invention, the technical personnel can also make simple deductions or replacements, and all of which should be considered to belong to the protection scope of the invention.

We claim:

1. A LCD driving circuit, comprising a data-driven chip with a plurality of output ends, and a plurality of data lines connected to the output ends of the data-driven chip respectively;
wherein output resistors are arranged between the output ends of said data-driven chip and the data lines respectively; equivalent resistances of said data lines being different; and the equivalent resistance of each of the data lines is equal to the sum of the output resistances corresponding to the data line.

2. The LCD driving circuit of claim 1, wherein the output ends of said data-driven chip are connected to the data lines on a glass substrate by the output resistors in series connection.

3. The LCD driving circuit of claim 2, wherein said output resistors are integrated in said data-driven chip.

4. The LCD driving circuit of claim 1, wherein said output resistors are arranged on a glass substrate where said data lines are arranged.

5. The LCD driving circuit of claim 1, wherein said output resistors are adjustable resistors.

6. The LCD driving circuit of claim 1, wherein said data-driven chip is arranged on a flexible circuit board.

7. The LCD driving circuit of claim 1, wherein said data-driven chip is directly connected to a lead arranged on an LCD laminated area.

8. A data-driven chip, wherein each output end of said data-driven chip is in series connected to an output resistor matched with the equivalent resistance of a data line connected to a data-driven chip correspondingly.

9. A liquid crystal panel, comprising the LCD driving circuit of claim 1; wherein said LCD driving circuit comprises a data-driven chip with a plurality of output ends, and a plurality of data lines connected to the output ends of the data-driven chip respectively, wherein output resistors are arranged between the output ends of the data-driven chip and the data lines respectively; equivalent resistances of the data lines are different; and the equivalent resistance of each of the data lines is equal to the sum of the output resistances corresponding to the data line.

10. The liquid crystal panel of claim 9, wherein the output ends of said data-driven chip are respectively connected to the data lines on a glass substrate by the output resistors in series connection.

11. The liquid crystal panel of claim 10, wherein said output resistors are integrated in said data-driven chip.

12. The liquid crystal panel of claim 9, wherein said output resistors are arranged on a glass substrate where said data lines are arranged.

13. The liquid crystal panel of claim 9, wherein said output resistors are adjustable resistors.

14. The liquid crystal panel of claim 9, wherein said data-driven chip is arranged on a flexible circuit board.

15. The liquid crystal panel of claim 9, wherein said data-driven chip is directly connected to a lead arranged on an LCD laminated area.

16. A liquid crystal panel, comprising the liquid crystal panel of claim 9; said liquid crystal panel comprising an LCD driving circuit, wherein the LCD driving circuit comprises a data-driven chip with a plurality of output ends, and a plurality of data lines connected to the output ends of the data-driven chip respectively, wherein output resistors are arranged between the output ends of the data-driven chip and the data lines respectively; equivalent resistances of the data lines are different; and the equivalent resistance of each of the data lines is equal to the sum of the output resistances corresponding to the data line.

17. The liquid crystal display of claim 16, wherein the output ends of said data-driven chip are connected to the data lines on a glass substrate by the output resistors in series connection.

18. The liquid crystal display of claim 17, wherein said output resistors are integrated in said data-driven chip.

19. The liquid crystal display of claim 16, wherein said output resistors are arranged on a glass substrate where said data lines are arranged.

20. The liquid crystal display of claim 16, wherein said output resistors are adjustable resistors.

21. The liquid crystal display of claim 16, wherein said data-driven chip is arranged on a flexible circuit board.

22. The liquid crystal display of claim 16, wherein said data-driven chip is directly connected to a lead arranged on an LCD laminated area.
